(19) United States
(12) Patent Application Publication
(10) Pub. No.: US 2015/0267094 A1
(43) Pub. Date: Sep. 24, 2015

(54) SILICONE FORMULATION WITH IMPROVED STORAGE STABILITY

(71) Applicant: SIKA TECHNOLOGY AG, Baar (CH)

(72) Inventor: Manuel FRIEDEL, Zurich (CH)

(73) Assignee: SIKA TECHNOLOGY AG, Baar (CH)

(21) Appl. No.: 14/730,877

(22) Filed: Jun. 4, 2015

Related U.S. Application Data
(63) Continuation of application No. PCT/EP2013/074870, filed on Nov. 27, 2013.

(30) Foreign Application Priority Data
Dec. 4, 2012 (EP) 12195526.4

(51) Int. Cl. C09J 183/06; C08K 5/544

(52) U.S. Cl. CPC C09J 183/06; C08K 5/544

(57) ABSTRACT

A one-component or two-component silicone formulation including: a) at least one cross-linkable poly(diorganosiloxane); b) at least one oligomeric siloxane as a cross-linker for the poly(diorganosiloxane), wherein the oligomeric siloxane is a condensation product of monomeric silane cross-linkers; and c) at least one functionalized oligo(dimethylsiloxane). The one-component or two-component silicone formulation is suitable as an elastic adhesive or sealant, for example, in the automotive and solar fields, for façade construction, insulation glass, window glass or for construction in general.

### RELATED APPLICATION(S)

This application claims priority as a continuation application under 35 U.S.C. §120 to PCT/EP2013/074870, which was filed as an International Application on Nov. 27, 2013 designating the U.S., and which claims priority to European Application No. 12195526.4 filed in Europe on Dec. 4, 2012. The entire contents of these applications are hereby incorporated by reference in their entireties.

### FIELD

The disclosure relates to one- or two-component silicone formulations, for example, RTV silicones and their usage and to a corresponding silicone component.

### BACKGROUND INFORMATION

Silicones are compositions which have been used as adhesives or sealants. Such silicones can be formed as one- or two-component silicone formulations and contain as main components a polyorganosiloxane and a cross-linker. A distinction is made between cold cross-linking RTV silicones (RTV=room-temperature cross-linking or room-temperature vulcanizing) and hot cross-linking HTV silicones (HTV=high-temperature cross-linking or high-temperature vulcanizing). One- and two-component RTV silicones are also designated as RTV 1 silicones and RTV 2 silicones.

The formulation of moisture-hardening RTV silicones that contain functional silanes, for example, tri- and tetra-functional silanes as cross-linkers is used. Formulations containing functional oligosiloxanes, that is, oligomers of functional silanes are also used. The advantage of such oligomeric compounds is, among other things, a distinct reduction of the low-molecular cleavage products that become free during the hardening reaction and therefore of the VOC emissions. Furthermore, silicone formulations with a higher flash point and therefore with improved work safety can be formulated.

However, silicone polymers, for example OH-terminated polydimethylsiloxanes with viscosities between 1000 and 350,000 mPas are frequently not readily miscible with the functional oligosiloxanes in contrast to the monomers. Mixtures of these oligomers with silicone oils display phase separation after a short time and are therefore not stable in storage. This is accompanied by changed qualities of the formulated RTV silicones such as reduced reactivity and reduced adhesion.

EP-A2-1191066 describes the usage of amino-functional oligosiloxanes as adhesion promoters in adhesive masses and sealing masses based on organopolysiloxanes and silane cross-linkers. No possibilities for improving the homogeneity of the mixtures are shown.

EP-A1-2439223 relates to amine/epoxy-copolymers which carry siloxane functionalities. Different usages for these amine/epoxy-copolymers are described, e.g., as dispersants for the dispersing of pigments or fillers in silicone oils.

WO 2011/006808 concerns cross-linkable compounds based on organosilicon compounds containing silyl-terminated polymers and describes the usage of aminoalkyl alkoxy silanes and their hydrolysates as adhesion promoters.

US-A1-2003/072873 describes the production of functional siloxanes and their usage as adhesion promoters. EP-A2-0997469 describes functional oligosiloxanes and their use as adhesion promoters in adhesive masses and sealing masses.

U.S. Pat. No. 4,710,405 describes the use of amino-functionalized poly(dimethylsiloxane) co-oligomers for improving the adhesion of silicone emulsions. The use of oligomeric silane cross-linkers is not described.

EP-A2-1136514 relates to the production of poly(3-aminopropylorganosiloxanes) and refers to the possible use in coatings and adhesives. EP-A1-0675128 refers to the production of aqueous silane polymers in which the functional silanes are used as stabilizers.

EP-A1-1894966 describes the use of a condensation product of functional oligosiloxanes as primers for the adhesion buildup for example of polyurethane-based adhesive substances and sealing substances on substrates.

As previously explained, mixtures of oligomeric silane cross-linkers with silicone oils display phase separation after a short time and are therefore not stable in storage, which is associated with other disadvantages. There is no solution for this problem in the related art.

JP 2010-100667 relates to a silicone formulation comprising an organopolysiloxane with hydroxy- or alkoxy residues, a hydrolysable silane or a partial hydrolysate of it and a dimethyl siloxane containing hydroxyl or alkoxy residues and with a degree of polymerization of 100-500.

V. Rajendra et al., LANGMUIR, vol. 28, No. 2, 2012, pp. 1470-1477 describes a one-component silicone formulation comprising OH-terminated polydimethylsiloxane, tetraethylorthosilicate and aminopropyl-terminated dimethylsiloxane.

EP 0861876 A2 describes a silicone formulation containing a cross-linkable polydiorganosiloxane with OH terminal residues, a monomeric silane cross-linker or a condensate of it and an oligodiorganosiloxane containing alkoxy residues.

US 2012/111498 A1 relates to two-component compounds comprising a hydroxy-terminated polydimethylsiloxane and hydrolyzable silane cross-linkers or a condensation product of them.

WO 2004/015002 describes heat-conductive silicone elastomer compositions that can contain organosiloxane oligomers as adhesion promoters.

### SUMMARY

According to one aspect, a one- or two-component silicone formulation is provided, comprising:

a) at least one cross-linkable polydiorganosiloxane,

b) at least one oligomeric siloxane as a cross-linker for the polydiorganosiloxane, wherein the oligomeric siloxane is a condensation product of monomeric silane cross-linkers, and

c) at least one functionalized oligodimethylsiloxane.

According to another aspect, a silicone component is provided, comprising:

a) at least one oligomeric siloxane wherein the oligomeric siloxane is a condensation product of monomeric silane cross-linkers, and

b) at least one functionalized oligodimethylsiloxane.

### DETAILED DESCRIPTION

The present disclosure addresses, for example, the problem of this phase separation and provides means for increasing the miscibility of the oligomeric siloxane cross-linkers with silicone oils and therefore improving the stability in storage. It was surprisingly found that the addition of certain functionalized oligodimethylsiloxanes improves the miscibility of functional oligosiloxanes with silicone oils.

The problem is therefore addressed, for example, by a one- or two-component silicone formulation that comprises a) at least one cross-linkable polydiorganosiloxane, b) at least one oligomeric siloxane as cross-linker for the polydiorganosiloxane, wherein the oligomeric siloxane is a condensation product of monomeric silane cross-linkers, and c) at least one functionalized oligodimethylsiloxane.

The silicone formulation according to the disclosure concerns a one- or two-component formulation, i.e., the silicone formulation includes one component or two separate components. In the case of the two-component silicone formulation, it is exemplary that the first component or polymer component A comprises the at least one polydiorganosiloxane and the second component or hardener component B comprises the at least one oligomeric siloxane and the at least one functionalized oligodimethylsiloxane. In a one-component silicone formulation, the one component contains the polydiorganosiloxane, the oligomeric siloxane and the functionalized oligodimethylsiloxane.

The one- or two-component silicone formulation can be a silicone formulation that cures at room temperature, that is, an RTV silicone, wherein a one-component RTV silicone is also designated as an RTV 1 silicone and a two-component RTV silicone is also designated as an RTV 2 silicone.

In the two-component silicone formulation, the cross-linking of the polyorganosiloxane is started by the mixing of the polymer component A containing the polyorganosiloxane with the hardener component B containing the cross-linker. Two-component silicone formulations are condensation-cross-linking RTV 2 systems and addition-cross-linking RTV 2 systems, wherein according to the disclosure, condensation-cross-linking two-component silicone formulations are exemplary as two-component systems. The one-component silicone formulations are, for example, moisture-curing systems in which the cross-linking of the polydiorganosiloxane takes place by the contact with moisture.

The one- or two-component silicone formulation comprises one or more polydiorganosiloxanes. The polydiorganosiloxanes are cross-linkable polydiorganosiloxanes. The polydiorganosiloxanes are, for example, polydimethylsiloxanes. Such polydimethylsiloxanes can be modified to adjust the properties in that a part or all of the methyl residues is/are replaced by other residues such as, e.g., vinyl, phenyl, 3,3,3-trifluoropropyl.

The polydiorganosiloxanes comprise, for example, functional residues by which a cross-linking is possible. For example, the polydiorganosiloxanes comprise two or more functional residues by which a cross-linking is possible. The term functional residues denotes here, for example, residues that can react with functional residues of the cross-linker under formation of a bond, wherein the reaction is optionally introduced by hydrolysis, alcoholysis or another splitting reaction in the functional residue of the polydiorganosiloxane and/or of the cross-linker. The reaction between the functional residue of the polydiorganosiloxane and of the functional residue of the cross-linker can take place by a condensation reaction.

These functional residues can be present in a side residue or a terminal residue of the polydiorganosiloxane, wherein terminal functional residues are exemplary (α,ω-functional polydiorganosiloxanes). Suitable terminal functional residues are those used in the art. Examples for such functional residues of polydiorganosiloxane which are, for example, terminal functional residues are hydrido-, hydroxy-, vinyl-, alkoxy-, acetoxy- and ketoxime residues, wherein hydroxy residues are exemplary. Examples are cited in the following. Polydiorganosiloxane comprises, e.g., 1 to 3, for example, 1 or 2 such functional residues on each end.

In general, e.g., at least one polydiorganosiloxane with the below formula is/are suitable as polydiorganosiloxanes for the silicone formulations in accordance with the disclosure.

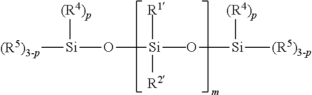

Here, the residues R^{1′}, R^{2′} and R⁴ stand independently of each other for linear or branched, monovalent hydrocarbon residues with 1 to 12 C atoms which optionally comprise one or more heteroatoms, and optionally one or more C—C multiple bonds and/or optionally cycloaliphatic and/or aromatic components, wherein residues selected from alkyl residues with 1 to 5, for example 1 to 3 C atoms, for example, methyl, vinyl, aryl, for example, phenyl, and alkaryl such as benzyl are exemplary. For example, the residues R^{1′} and R^{2′} stand for alkyl residues with 1 to 5, for example with 1 to 3 C atoms, for example, for methyl residues, wherein a part of the alkyl residues, for example, methyl, can be replaced by other residues such as vinyl or phenyl. The residues R⁴ can stand for phenyl-, vinyl or for methyl residues.

The residues R⁵ stand independently of each other for hydroxyl residues or for alkoxy-, acetoxy- or ketoxime residues each with 1 to 13 C atoms that optionally comprise one or more heteroatoms, and optionally one or more C—C multiple bonds and/or optionally cycloaliphatic and/or aromatic components. R⁵ can be hydroxy.

Exemplary alkoxy residues are C₁-C₅-alkoxy residues and methoxy, ethoxy and propoxy are exemplary. Exemplary ketoxime residues are dialkylketoxime residues whose alkyl residues have 1 to 6 C atoms. The two alkyl residues of the dialkylketoxime residues can stand independently of one another for methyl-, ethyl-, n-propyl-, iso-propyl-, n-butyl- or iso-butyl residues. Those cases are exemplary in which an alkyl residue of dialkylketoxime stands for a methyl residue and the other alkyl residue of the dialkylketoxime for a methyl-, ethyl-, n-propyl- or for an iso-butyl residue. The ketoxime residue can stand for an ethyl-methylketoxime residue.

The index p stands for a value of 0, 1 or 2. The index m can be selected within wide ranges according to the intended use, in general in such a manner that a silicone oil is obtained. The index m can be, e.g., in the range of 10 to 10,000, for example, 100 to 1,000. The index m can be selected in such a manner that the polydiorganosiloxane has the viscosity indicated in the following.

The viscosity of the polydiorganosiloxanes used can vary within wide ranges according to the intended use. The polyorganosiloxane or polydiorganosiloxane used in accordance with the disclosure can have, e.g., a viscosity at a temperature of 23° C. of 10 to 500,000 mPas, for example, 1,000 to 350,000 mPas, for example, from 6,000 to 120,000 mPas.

The viscosities indicated here and in the following can be determined in accordance with DIN 53018. The measuring can take place with a cone-plate viscosimeter MCR 101 of the company Anton-Paar, Austria, with cone-type CP 25-1 at 23° C. The indicated viscosity values refer to a shear rate of 0.5 s⁻¹.

Exemplary polydiorganosiloxanes are polydimethylsiloxanes with functional terminal residues such as hydrido, hydroxy-, alkoxy-, acetoxy- and ketoxime residues, wherein hydroxy residues are exemplary. OH-terminated polydimethylsiloxanes (α,ω-hydroxy-functional polydimethylsiloxanes) are exemplary. As was previously explained, such polydimethylsiloxanes can be modified by the partial inclusion of other residues such as phenyl instead of methyl.

The one-or two-component silicone formulation furthermore comprises one or more oligomeric siloxanes as cross-linkers for the polyorganosiloxane, wherein the oligomeric siloxane is a condensation product of monomeric silane cross-linkers. Monomeric silane cross-linkers and also oligomeric condensation products of them are cross-linkers for silicone formulations.

Monomeric silane cross-linkers are in general silane compounds containing two or more, e.g., three or more, for example, 3 or 4 functional residues. The term functional residues denotes here, for example, residues that can react with functional residues of polyorganosiloxane under formation of a bond, wherein the reaction is optionally introduced by hydrolysis, alcoholysis or another splitting reaction in the functional residue of the polydiorganosiloxane and/or of the cross-linker. The functional residues can be present at any position of the silane cross-linker and can be bound to an Si atom of the monomeric silane cross-linker.

Examples of functional residues that can have a monomeric silane cross-linker are alkoxy residues such as C₁₋₅ alkoxy residues, for example, methoxy-, ethoxy- or propoxy residues, acetoxy residues, amide residues, for example, N-alkylamide residues, for example, N-methylbenzamide- or N-methylacetamide residues, amine residues, for example, alkylated amine residues such as, for example, cyclohexylamine, for example, dialkylated amine residues such as, for example, N,N-diethylamine, halogen atoms, for example, chlorine and/or bromine atoms as well as hydrido substituents or oxime residues. Reference is made to the previously described exemplary ketoxime residues as examples of oxime residues. These functional residues can be present at any position of the silane cross-linker and can be bound to an Si atom of the monomeric silane cross-linker.

Monomeric silane cross-linkers can have, e.g., one of the following formulas (I) to (III).

(R⁶)_{q}—Si—(R⁷)_{4-q} (I)

(R⁷)₃—S—R⁸—Si—(R⁷)₃ (II)

N(H)ₙ(Si—(R⁷)₃)₃₋ₙ (III)

The residue R⁶ stands independently of each other for a linear or branched monovalent hydrocarbon residue with 1 to 12 C atoms that optionally comprises one or more heteroatoms, and optionally one or more C—C multiple bonds and/or optionally cycloaliphatic and/or aromatic components. Examples for R⁶ are alkyl residues with 1 to 5 C atoms, for example, methyl, ethyl or propyl, vinyl, aryl residues, such as phenyl, cycloalkyl residues, such as cyclohexyl, as well as substituted alkyl residues, with 1 to 8 C atoms, for example, methyl, ethyl or propyl, that are functionalized with one or more substituents such as optionally substituted amino (NH₂, NHR, NR₂, wherein R is independently of one another alkyl, aryl or cycloalkyl), mercapto, glycidoxy, methacrylate, acrylate or carbamato.

The residue R⁷ stands independently of each other for a hydroxyl residue or for an alkoxy-, acetoxy- or ketoxime residue each with 1 to 13 C atoms that optionally comprise one or more heteroatoms, and optionally one or more C—C multiple bonds and/or optionally cycloaliphatic and/or aromatic components. Exemplary ketoxime residues and alkoxy residues have already been previously described.

Furthermore, the subscript q stands for value of 0 to 4, under the condition that if q stands for a value of 3 or 4, at least q−2 R⁶ residues have at least one residue that reacts with the functional residues of polyorganosiloxane. For example, q stands for a value of 0, 1 or 2, for example, for a value of 0 or 1.

R⁸ is a bivalent alkylene residue, e.g., a C₁₋₆-alkylene residue, for example methylene, ethylene or propylene, an arylene residue such as phenylene, or a cycloalkylene residue, wherein alkylene is exemplary. The subscript n stands for 0, 1 or 2, for example, 1.

Concrete examples from monomeric silane cross-linkers are methyltrimethoxysilane, vinyltrimethoxysilane, phenyltrimethoxysilane, propyltrimethoxysilane, 3-mercaptopropyltrimethoxysilane, 3-aminopropyltrimethoxysilane, 3-methacryloxypropyltrimethoxysilane, 3-glycidoxypropyltrimethoxysilane, 2-aminoethyl-3-aminopropyltrimethoxysilane, 1,2-bis-(trimethoxysilyl)ethane, bis-(trimethoxysilylpropyl)amine, N-(n-butyl)-3-aminopropyltrimethoxysilane, N-cyclohexylaminomethyltrimethoxysilane, methacryloxymethyltrimethoxysilane, O-methylcarbamatomethyltrimethoxysilane or the corresponding compounds in which the methoxy residue is replaced by ethoxy, propoxy, oxime or ketoxime. Other examples are tetramethoxysilane, tetraethoxysilane and tetrapropoxysilane.

The oligomeric siloxane as cross-linker is a condensation product of one or more such monomeric silane cross-linkers. Such oligomeric siloxanes are commercially available, e.g., under the trade names Dynasylan® 1146, Dynasylan® 6490 of the company Evonik Degussa GmbH. Oligomers of functional silanes are complicatedly constructed 3-dimensional compounds. The oligomeric siloxane can be formed, e.g., from the hydrolysis and condensation of one or more equal or different monomeric silane cross-linkers.

The oligomeric siloxane contains functional residues stemming from the monomeric silane cross-linker. For example, a first condensation of two tetramethoxysilane molecules results in a dimer that contains six functional residues; the linking is formed from a functional residue of each molecule by condensation. As already explained, the structure of the oligomers formed can be complicated. The number of functional residues in the oligomer can vary according to the degree of condensation, the type of condensation and the monomeric silane cross-linkers used but is at least 2, e.g., 4 or more.

The degree of condensation of the oligomeric siloxane, that is, the number of the monomeric silane cross-linkers condensed with each other, can vary in wide ranges according to the intended use but can be, e.g., in a range of 2 to 200, for example, of 4 to 50. It is understandable that the degree of condensation, for example, in the case of rather high degrees of condensation, is frequently only an average value.

The amount of the oligomeric siloxane as cross-linker can vary within wide ranges. For example, the oligomeric siloxane can be present in a 1-component silicone formulation in an amount of 0.1 and 25 wt %, for example, 0.3 to 20 wt %, for example, of 1 and 15 wt % relative to the total mass. Oligomeric siloxanes are used in 2-component silicone formulations as cross-linkers usually substantially only in the hardener component and can be there in amounts of 0.5 and 75 wt %, for example, 1 to 50 wt %, for example, of 3 to 30 wt % relative to the total mass of the hardener component.

If the silicone formulation used is a two-component silicone formulation with a polymer component A comprising the at least one polydiorganosiloxane, and with a hardened component B comprising the at least one oligomeric siloxane and the at least one functionalized oligodimethylsiloxane, the weight ratio of polymer component A to hardener component B is, e.g., 1:1, for example, from 3:1 to 15:1, for example, 10:1 to 13:1.

These oligomeric siloxanes cannot be mixed or only poorly mixed with traditional polydiorganosiloxanes, for example polydimethylsiloxanes. This results in problems of the storage stability of formulated silicone products.

These problems can be mitigated or avoided according to the disclosure if molecules are added whose chemical structure is between those of the cited oligomeric siloxanes and those of the polydiorganosiloxanes, for example, of the polydimethylsiloxanes. This is surprisingly the case with functionalized oligodimethylsiloxanes, whose structure is substantially chain-shaped or star-shaped, that is, rather 2-dimensional. The latter can be functionalized in the siloxane chain and/or on the chain ends.

The one- or two-component silicone formulation therefore furthermore comprises a functionalized oligodimethylsiloxane. This can be, for example, a linear functionalized oligodimethylsiloxane. The functionalized oligodimethylsiloxane comprises at least one terminal or side functionalizing residue. For example, the functionalized oligodimethylsiloxane does not have more than 20, for example, not more than 10 terminal or side functionalizing residues.

The functionalizing residue comprises as functionalization one or more residues, e.g., one or more polar residues that is/are bound via a bridge residue to an Si atom of the functionalized oligodimethylsiloxane. Examples for the functionalizing residues are mercapto, glycidoxy, amino (e.g., NH₂, NHR or NR₂ wherein R is independently of each other alkyl, aryl, cycloalkyl), amido methacrylato, carbamato (e.g., O—C₁-C₄-alkylcarbamato such as O-methylcarbamato), isocyanato or polyalkylene glycol, for example polyethylene or polypropylene glycol and their copolymers (EO, PO or EO—PO).

The bridge residue can be, e.g., an alkylene-, e.g., C₁-C₅-alkylene-, arylene-, e.g., phenylene-, or cycloalkylene residue, wherein alkylene is exemplary, for example methylene, ethylene or n-propylene, wherein n-propylene is exemplary. The bridge residue can also be, e.g., a silyloxy- or alkylsilyloxy residue, e.g., alkyldialkoxysilyloxy, alkyldimethylsilyloxy or alkylmethylalkoxysilyloxy, wherein alkyl can be C₁-C₄-alkyl, and alkoxy can be C₁-C₄-alkoxy. The functionalizing residue can also contain two or more functionalizing residues, e.g., an aminoalkylaminoalkyl residue.

Exemplary functionalizing residues are residues with the formula (1) R^{F}-alkyl-, the formula (2) R^{F}-alkyl-Si(R^{S})₂—O—, the formula (3) aminoalkylaminoalkyl and the formula (4) aminoalkylaminoalkylaminoalkyl, wherein in the formulas (1) to (4) R^{F} is selected from mercapto, glycidoxy, amino (e.g., NH₂, NHR or NR₂ wherein R is independently of each other C₁-C₄-alkyl, aryl such as phenyl, C₄-C₇-cycloalkyl), amido, methacrylato, carbamato, isocyanato or polyalkylene glycol, for example polyethylene or polypropylene glycol and their copolymers, alkyl is independently of each other, for example, C₁-C₄-Alkyl, for example, methyl, ethyl and propyl, R^{S} is independently of each other C₁-C₄-alkyl, for example methyl, or C₁-C₄-alkoxy, for example methoxy and ethoxy.

The functionalizing residue can be a non-hydrolysable residue. Regarding the functionalizing residue, in general, in contrast to the above-cited functional residues, no cross-linking with the functional residues of polydiorganosiloxane is possible, at least under the conditions under which the silicone formulation is cured.

The functionalizing residue can be, e.g., a polar residue. Concrete examples for the functionalizing residue, that is bound to an Si atom of oligodimethylsiloxane, are 3-aminopropyl, 2-aminoethyl-3-aminopropyl, 2-aminoethyl-2-aminoethyl-3-aminopropyl, EO-alkyl (polyethylene glycolalkyl, e.g., EO-propyl (polyethylene glycolpropyl, e.g., with an average number of 8 ethylene oxide residues), EO—PO-alkyl, ω-amidoalkyl, 3-mercaptopropyl, 3-glycidyloxypropyl, N-cyclohexylaminomethyl, 3-methacrylatopropyl, methacrylatomethyl, 3-isocyanatopropyl, O-methyl-carbamatomethyl, O-methyl-carbamatopropyl, EO-alkyldimethylsilyloxy, EO-alkylmethylalkoxysilyloxy, EO-alkyldialkoxysilyloxy, EO—PO-alkyldimethylsilyloxy, EO—PO-alkylmethylalkoxysilyloxy, EO—PO-alkyldialkoxysilyloxy, amino-alkyldimethylsilyloxy, amino-alkylmethylalkoxysilyloxy, amino-alkyldialkoxysilyloxy, alkyldimethylsilyloxy, EO-alkylmethylalkoxysilyloxy and EO-alkyldialkoxysilyloxy.

The degree of condensation or degree of polymerization of the functionalized oligodimethylsiloxane can vary in wide ranges according to the intended use but can be, e.g., in a range of 5 to 5000, for example, of 10 to 1000, for example, of 20 to 800, for example, 10 to 500 or 20 to 500. It is understandable that the degree of condensation, for example, in the case of rather high degrees of condensation, is frequently only an average value.

Examples of functionalized oligodimethylsiloxanes can comprise one of the two following general formulas, wherein the substituent Me represents methyl residues.

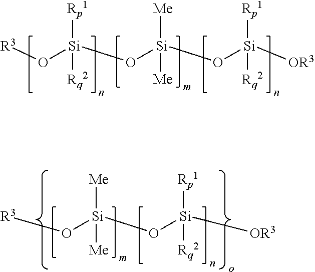

In the above two general formulas R¹ is independently of each other a functionalizing residue such as described above, for example, a residue with the formula (1) R^{F}-alkyl-, the formula (2) R^{F}-alkyl-Si(R^{S})₂—O—, the formula (3) aminoalkylaminoalkyl or the formula (4) aminoalkylaminoalkylaminoalkyl, wherein in the formulas (1) to (4) R^{F} is selected from mercapto, glycidoxy, amino (e.g., NH₂, NHR or NR₂ wherein R is independently of each other C₁-C₄-alkyl, aryl such as phenyl, C₄-C₇-cycloalkyl), amido, methacrylato, carbamato, isocyanato or polyalkyleneglycol, for example polyethylene- or polypropylene glycol and their copolymers, alkyl can be independently of each other C₁-C₄-alkyl, for example, methyl, ethyl and propyl, R^{S} is independently of each other C₁-C₄-alkyl, for example, methyl, or C₁-C₄-alkoxy, for example methoxy and ethoxy.

R² is independently of each other alkyl, for example, methyl, hydroxy, alkoxy, such as methoxy or ethoxy, alkyldimethylsilyloxy, alkylmethylalkoxysilyloxy or alkyldialkoxysilyloxy. R³ can be H or alkyl. In the previous examples for R² and R³ alkyl or alkoxy can be, e.g., C₁-C₄-alkyl or C₁-C₄-alkoxy.

Furthermore, the following is true: m=5-5000, for example, 10-1000, for example, 20-800, for example, 10-500 or 20-500; n=1-15, o=1-50, p=1 or 2, q=0 or 1 with p+q=2.

Examples for R¹ are 3-aminopropyl, 2-aminoethyl-3-aminopropyl, 2-aminoethyl-2-aminoethyl-3-aminopropyl, EO-alkyl (polyethylene glycolalkyl, e.g., EO-propyl (polyethylene glycolpropyl, e.g., with an average number of 8 ethylene oxide residues), EO—PO-alkyl, ω-amidoalkyl, 3-mercaptopropyl, 3-glycidyloxypropyl, N-cyclohexylaminomethyl, 3-methacrylatopropyl, methacrylatomethyl, 3-isocyanatopropyl, O-methyl-carbamatomethyl, O-methyl-carbamatomethyl, EO-alkyldimethylsilyloxy, EO-alkylmethylalkoxysilyloxy, EO-alkyldialkoxysilyloxy, EO—PO-alkyldimethylsilyloxy, EO—PO-alkylmethylalkoxysilyloxy, EO—PO-alkyldialkoxysilyloxy, amino-alkyldimethylsilyloxy, amino-alkylmethylalkoxysilyloxy, amino-alkyldialkoxysilyloxy, alkyldimethylsilyloxy, EO-alkylmethylalkoxysilyloxy and EO-alkyldialkoxysilyloxy. In the previous examples alkyl or alkoxy can be, e.g., C₁-C₄-alkyl or C₁-C₄-alkoxy.

The functionalized oligodimethylsiloxane can be present in an amount of 0.01 to 10 wt %, for example, of 0.1 to 8 wt %, for example, of 0.5 to 5 wt % relative to the total mass of the silicone formulation. The functionalized oligodimethylsiloxane is present, for example, in the same component as the oligomeric siloxane.

In an exemplary embodiment, the functionalized oligodimethylsiloxane has an HLB value less than or equal to 15, for example, less than or equal to 12, for example, less than or equal to 9. The HLB value (“hydrophilic-lipophilic balance”) is a value familiar to a person skilled in the art and can be calculated according to a method described in Griffin, W. C., Calculation of HLB values of non-ionic surfactants, J. Soc. Cosm. Chem. 5 (1954), p. 259.

The one-or two-component silicone formulation can optionally contain even other components such as are customary for a one-or two-component silicone formulation. Such additional components are, e.g., catalysts, softeners, inorganic and/or organic fillers, curing accelerators, pigments, adhesion promoters, auxiliary processing agents, rheology modifiers, stabilizers, dyes, inhibitors, heat stabilizers, antistatic agents, flame protection agents, biocides, waxes, flow-control agents, thixotropic agents and other raw materials and additives familiar to the person skilled in the art. The one- or two-component silicone formulation can also contain, in addition to the oligomeric siloxanes, monomeric silane cross-linkers such as described above.

Customary additives obtainable, e.g., in commerce can be used. The addition of such additives is a familiar practice for such silicone formulations. The person skilled in the art is familiar, as a function of the initial formulation and the intended use, with the selection of suitable additives and with the amount to be added for the particular component.

In a two-component system, the additives can be added to one or to both components. For example, all additives are basically suitable for the polymer component as well as for the silicone component comprising the at least one oligomeric siloxane and the at least one functionalized oligodimethylsiloxane, that can be added as hardener component.

The silicone formulation, for example, the one-component silicone formulation contains, e.g., a catalyst for the cross-linking of the polyorganosiloxane. Suitable catalysts are commercially obtainable. Customary catalysts are, e.g., stannous organic compounds or titanates.

An example for softeners that can be optionally used are trialkylsilyl-terminated polydimethylsiloxanes, wherein the trialkylsilyl-terminated polydimethylsiloxanes can have a viscosity at 23° C. in a range of 1 to 10,000 mPas. Trimethylsilyl-terminated polydimethylsiloxanes can also be used in which a few of the methyl residues are replaced by other organic residues such as, for example, phenyl-, vinyl- or trifluoropropyl residues. The polydimethylsiloxane can also be monofunctional, i.e., one end is reactive, e.g., via a hydroxy terminal residue. Certain hydrocarbons can also be added as softeners.

The silicone formulation can optionally comprise one or more fillers with which, e.g., rheological properties of the non-cured formulation as well as the mechanical properties and the surface condition of the cured formulation can be influenced. It can be advantageous to use a mixture of different fillers.

Examples for suitable fillers are inorganic or organic fillers such as natural, ground or precipitated calcium carbonates, that are optionally coated with fatty acids, for example, stearic acid, calcined caolines, aluminum oxides, aluminum hydroxides, silicic acids, for example, highly dispersed silicic acids from pyrolysis processes, carbon black, for example, industrially produced carbon black, aluminum silicates, magnesium-aluminum silicates, circle rhodium silicates, quartz meal, cristobalite meal, diatomaceous earth, mica, iron oxides, titanium oxides, zirconium oxides, gypsum, annaline, barium sulfate, boron carbide, boron nitride, graphite, carbon fibers, zeolites, glass fibers or hollow glass spheres, whose surface is optionally treated with a hydrophobic agent. Exemplary fillers are calcium carbonates, calcined caolines, carbon black, highly dispersed silicic acids and flame-retardant fillers such as hydroxides or hydrates, for example, hydroxides or hydrates of aluminum, for example, aluminum trihydroxide.

The one-or two-component silicone formulations in accordance with the disclosure, for example, in the form of an RTV silicone, are suitable as elastic adhesives or sealants. A suitable area of application is, e.g., the adhering or sealing of objects consisting of glass, metal, e.g., aluminum, copper or high-grade steel, or plastic, e.g., PVC, polyamide, polycarbonate or PET. The silicone formulations in accordance with the disclosure can be used as adhesives or sealants for the areas of automobile or solar, façade construction, insulating glass or window glass and in general for construction.

### EXAMPLES

Concrete exemplary embodiments of the disclosure are explained in the following but are not intended to limit the scope of the disclosure. Unless otherwise indicated, data refers to the weight.
The following commercial products, among others, are used in the examples:
Hansa®ADD 8080 Bezema AG, diaminofunctional oligosiloxane
Tegomer®A-Si2322 Evonik Goldschmidt GmbH, aminoalkyloligodimethylsiloxane
Geniosil®GF94 Wacker Chemie AG, 2-aminoethyl-3-aminopropyltriethoxysilane
Dynasylan®1146 Evonik Industries, a co-oligomer of an alkyl-functional and of a diaminofunctional silane
Dynasylan 6490 Evonik Industries, oligomeric vinylsilane

The amounts indicated in the following tables were weighed in and mixed on a speed mixer of the company Hauschild at 23° C. and 50% RH for 40 s at 2000 rpm.

The mixtures 1-13 obtained were stored sealed airtight in transparent polypropylene containers at 23° C. For the examples 14-21 the hardener component B was filled into cartridges, sealed airtight, stored standing at 23° C. and further processed without remixing.

Phase separations in the examples 1-13 were visually observed. The storage was halted after 6 months when no phase separation was able to be observed up to then.

In order to determine the pot life the example components 14-21 were intimately mixed in a weight ratio of 1:13 with a polymer component. The mixing took place on a speed mixer from Hauschild and the mixing was carried out at 23° C. and 50% RH for 20 s at 2200 rpm. A wooden spatula was dipped into the mixture and withdrawn at regular intervals without previous agitation. The pot time is the time after which the spatula can no longer be withdrawn without resistance. The polymer component used for the test has the following composition:

45 wt % α,ω-OH-terminated polydimethylsiloxane with a viscosity of 6000 mPas, 15 wt % trimethylsilyl-terminated polydimethylsiloxane with a viscosity of 100 mPas, 20 wt % aluminiumtrihydroxide (Apyral®4 of the company Nabaltec), 20 wt % natural stearine-coated chalk (OMYA®BLR/3 of the company OMYA).

In order to determine the adhesion the example components 14-21 were intimately mixed in a weight ratio of 1:13 with the above-cited polymer component. The mixing took place on a speed mixer from Hauschild and the mixing was carried out at 23° C. and 50% RH for 20 s at 2200 rpm. The mixture was applied with a layer thickness of ca. 2 mm directly on the surface of float glass panes with the dimensions 75×150×5 mm. The float glass panes were previously degreased with isopropanol. The coated glass panes were cured 7 d at 23° C. and 50% RH and subsequently placed in 55° C. warm water. The adhesion was determined by a subsequent peeling test.

During the peeling test, a cut was made at the end of the coated float glass just above the adhesive surface. The cut end of the silicone adhesive is held fast with 2 fingers and drawn at an angle of >90° from the base. This took place by a careful drawing of the adhesive and by placing a cut vertically to the direction of drawing up to the clean base. The drawing-off speed is selected in such a manner that a cut is made about every 3 seconds. The test stretch corresponds to at least 8 cm. The adhesive remaining after the drawing-off of the silicone on the base is evaluated (cohesion break). The evaluation of the adhesive properties takes place by estimating the cohesive amount of the adhesion surface:

The percentage data refers to the amount of the cohesion break. A result of 100% means that the silicone coating cohesively breaks 100% in the peeling test. 0% cohesion break signifies a purely adhesive break.

| | Vinylmethylmethoxysilyl- | | | |
|---|---|---|---|---|
| | terminated | | Functionalized | |
| | poly(dimethylsiloxane), | Functional | oligodimethyl- | |
| Ex. | 50′000 mPas | oligomer | siloxane | Time to separation |
| 1 Cf. | 100 g | 5 g | 0 g | 31 d |
| | | Dynasylan | | |
| | | 1146 | | |
| 2 Cf. | 100 g | 10 g | 0 g | 22 d |
| | | Dynasylan | | |
| | | 1146 | | |
| 3 Cf. | 100 g | 20 g | 0 g | 7 d |
| | | Dynasylan | | |
| | | 1146 | | |
| 4 Cf. | 100 g | 10 g | 0 g | 15 d |
| | | Dynasylan | | |
| | | 6490 | | |
| 5 | 100 g | 10 g | 0.5 g | 100 d |
| | | Dynasylan | Hansa ADD | |
| | | 1146 | 8080 | |
| 6 | 100 g | 10 g | 1 g | No separation |
| | | Dynasylan | Hansa ADD | in 6 months |
| | | 1146 | 8080 | |
| 7 | 100 g | 10 g | 2 g | No separation |
| | | Dynasylan | Hansa ADD | in 6 months |
| | | 1146 | 8080 | |
| 8 | 100 g | 10 g | 1 g | 120 d |
| | | Dynasylan | Hansa ADD | |
| | | 1146 | 8038 | |
| 9 | 100 g | 10 g | 1 g | 95 d |
| | | Dynasylan | Tegomer A-Si | |
| | | 1146 | 2322 | |
| 10 | 100 g | 10 g | 2 g | No separation |
| | | Dynasylan | Tegomer A-Si | in 6 months |
| | | 1146 | 2322 | |
| 11 | 100 g | 10 g | 1 g | No separation |
| | | Dynasylan | Hansa ADD | in 6 months |
| | | 6490 | 8080 | |
| 12 | 100 g | 10 g | 1 g | 150 d |
| | | Dynasylan | Tegomer A-Si | |
| | | 6490 | 2322 | |
| 13 | 100 g | 10 g | 2 g | No separation |
| | | Dynasylan | Tegomer A-Si | in 6 months |
| | | 6490 | 2322 | |

| | Example | | | | | | | |
|---|---|---|---|---|---|---|---|---|
| | 14 Cf. | 15 Cf. | 16 | 17 | 18 | 19 | 20 | 21 |
| Vinylmethyl- | 60 g | 60 g | 59.5 g | 58.5 g | 53.5 g | 59.5 g | 59.5 g | 58.5 g |
| methoxysilyl- | | | | | | | | |
| terminated | | | | | | | | |
| poly(dimethyl | | | | | | | | |
| siloxane), | | | | | | | | |
| 50′000 mPas | | | | | | | | |
| 1,2-bis(triethoxy- | 18 g | 18 g | 18 g | 18 g | 18 g | 18 g | 18 g | 18 g |
| silyl)ethane | | | | | | | | |
| Vinyltrimethoxy- | 12 g | 12 g | 12 g | 12 g | 12 g | 12 g | 12 g | 12 g |
| silane | | | | | | | | |
| Tetraethyl- | 4.5 g | 4.5 g | 4.5 g | 4.5 g | 4.5 g | 4.5 g | 4.5 g | 4.5 g |
| orthosilicate | | | | | | | | |
| Functional | 5 g | 5 g | 5 g | 5 g | 10 g | 5 g | 5 g | 5 g |
| Oligosiloxane | Geniosil | D* | D* | D* | D* | D* | D* | D* |
| | GF94 | | | | | | | |
| Functionalize | | | 0.5 g | 1.5 g | 1.5 g | 0.5 g | 0.5 g | 1.5 g |
| d oligomer | | | AD* | AD* | AD* | AD* | AS* | AS* |
| Dibutyl stannous | 0.5 g | 0.5 g | 0.5 g | 0.5 g | 0.5 g | 0.5 g | 0.5 g | 0.5 g |
| diacetate | | | | | | | | |
| Adhesion on | 100% | 75% | 50% | 100% | 100% | 100% | 50% | 100% |
| glass (14 d 55° C. | | | | | | | | |
| water bath) | | | | | | | | |
| Adhesion on | 100% | 0% | 50% | 100% | 100% | 100% | 50% | 100% |
| glass after 4 | | | | | | | | |
| weeks storage of | | | | | | | | |
| the components | | | | | | | | |
| (14 d 55° C. water | | | | | | | | |
| bath) | | | | | | | | |
| Pot time [min] | 6 | 11 | 21 | 19 | 16 | 29 | 64 | 42 |
| Pot time after 4 | 8 | 39 | 22 | 20 | 17 | 28 | 61 | 43 |
| weeks storage of | | | | | | | | |
| the components | | | | | | | | |
| [min] | | | | | | | | |

D* Dynasylan 1146, AD*: Hansa ADD 8080, AS*: Tegomer A-Si2322

It is apparent from these tables that functional oligomeric siloxanes show phase separation after mixing with silicone oils and that the properties of a corresponding silicone formulation become poorer after storage. The addition of functionalized oligodimethylsiloxanes in accordance with the disclosure delays or prevents the phase separation and the properties of a corresponding silicone formulation remain unchanged.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A one- or two-component silicone formulation, comprising:
a) at least one cross-linkable polydiorganosiloxane,
b) at least one oligomeric siloxane as a cross-linker for the polydiorganosiloxane, wherein the oligomeric siloxane is a condensation product of monomeric silane cross-linkers, and
c) at least one functionalized oligodimethylsiloxane.

2. The one- or two-component silicone formulation according to claim 1, wherein the functionalized oligodimethylsiloxane is a linear functionalized oligodimethylsiloxane.

3. The one- or two-component silicone formulation according to claim 1, wherein the functionalized oligodimethylsiloxane is an oligodimethylsiloxane that comprises terminally or laterally at least one functionalizing residue bound to an Si atom, which residue comprises at least one functionalizing residue selected from mercapto, glycidoxy, amino, amido, methacrylato, carbamato, isocyanato, or polyalkylene glycol.

4. The one- or two-component silicone formulation according to claim 1, wherein the functionalized oligodimethylsiloxane has one of the two following general formulas, 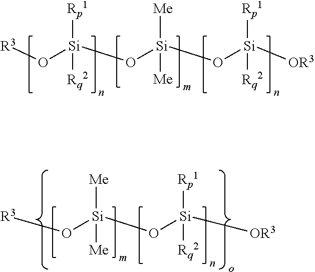
wherein the substituent Me represents methyl residues,
R¹ is independently of each other a functionalizing residue selected from a residue with the formula (1) R^{F}-alkyl-, the formula (2) R^{F}-alkyl-Si(R^{S})₂—O—, the formula (3) aminoalkylaminoalkyl, or the formula (4) aminoalkylaminoalkylaminoalkyl, wherein in the formulas (1) to (4), R^{F} is selected from mercapto, glycidoxy, amino, amido, methacrylato, carbamato, isocyanato or polyalkylene glycol; and R^{S} is independently of each other C₁-C₄-alkyl or C₁-C₄-alkoxy,
R² is independently of each other alkyl, hydroxy, alkoxy, alkyldimethylsilyloxy, alkylmethylalkoxysilyloxy or alkyldialkoxysilyloxy,
R³ is H or alkyl, and
m=5-5000; n=1-15, o=1-50, p=1 or 2, q=0 or 1 with p+q=2.

5. The one- or two-component silicone formulation according to claim 1, wherein the degree of condensation of the functionalized oligodimethylsiloxane is in the range of 5 to 5000.

6. The one- or two-component silicone formulation according to claim 1, wherein the silicone formulation is a two-component silicone formulation, wherein the first component as polymer component A comprises the at least one polydiorganosiloxane and the second component as hardener component B comprises the at least one oligomeric siloxane and the at least one functionalized oligodimethylsiloxane.

7. The one- or two-component silicone formulation according to claim 1, wherein the polydiorganosiloxane has a viscosity in the range of 1000 to 350000 mPas at a temperature of 23° C.

8. The one- or two-component silicone formulation according to claim 1, wherein the polydiorganosiloxane is a polydimethylsiloxane.

9. The one- or two-component silicone formulation according to claim 1, wherein the oligomeric siloxane is a condensation product of one or more monomeric silane cross-linkers and the monomeric silane cross-linker is a silane compound with two or more functional residues selected from at least one of alkoxy residues, acetoxy residues, oxime residues, amino residues, or N-methylamido residues.

10. The one- or two-component silicone formulation according to claim 1, wherein the oligomeric siloxane is contained in a one-component silicone formulation in an amount of 0.1 to 25 wt %, relative to the total weight of the silicone formulation, and in a two-component silicone formulation in the hardener component B in an amount of 0.5 to 75 wt %, relative to the total weight of the hardener component.

11. The one- or two-component silicone formulation according to claim 1, wherein the functionalized oligodimethylsiloxane is contained in an amount of 0.01 to 10 wt %, relative to the total mass of the silicone formulation.

12. The one- or two-component silicone formulation according to claim 1, wherein the silicone formulation is an adhesive or a sealant.

13. A silicone component, comprising:
a) at least one oligomeric siloxane wherein the oligomeric siloxane is a condensation product of monomeric silane cross-linkers, and
b) at least one functionalized oligodimethylsiloxane.

14. A method of using the one- or two-component silicone formulation according to claim 6, comprising mixing the polymer component A with the hardener component B.

15. A method of applying a formulation, comprising:
applying the one- or two-component silicone formulation according to claim 1 to a surface.

16. The one- or two-component silicone formulation according to claim 4, wherein m=10-1000.

17. The one- or two-component silicone formulation according to claim 1, wherein the degree of condensation of the functionalized oligodimethylsiloxane is in the range of 10 to 500.

18. The one- or two-component silicone formulation according to claim 1, wherein the polydiorganosiloxane is a hydroxy-terminated polydimethylsiloxane.

19. The one- or two-component silicone formulation according to claim 1, wherein the oligomeric siloxane is a condensation product of one or more monomeric silane cross-linkers and the monomeric silane cross-linker is a silane compound with three or more functional residues selected from at least one of alkoxy residues, acetoxy residues, oxime residues, amino residues, or N-methylamido residues.
